(19) United States
(12) Patent Application Publication
(10) Pub. No.: US 2008/0162459 A1
(43) Pub. Date: Jul. 3, 2008

(54) SYSTEM AND METHOD FOR MATCHING PARTIES WITH INITIATION OF COMMUNICATION BETWEEN MATCHED PARTIES

(76) Inventor: ELIEZER PORTNOY, NEW YORK, NY (US)

Correspondence Address: TURNING POINT LAW, 100 SMITH RANCH ROAD, SUITE 116, SAN RAFAEL, CA, 94903, US

(21) Appl. No.: 11/766,054

(22) Filed: Jun. 20, 2007

Related U.S. Application Data
(60) Provisional application No. 60/813,605, filed on Jun. 20, 2006.

(51) Int. Cl. G06F 7/06

(52) U.S. Cl. 707/5; 707/E17.014

(57) ABSTRACT

The invention provides for systems and methods for matching employer's jobs with prospective candidates and brokering instant communication between the employer and the candidate. The candidate receives a communication regarding the employer's job in the language of the candidate's choice, and the candidate is given the opportunity to instantly communicate with the employer according to the communication method selected by the employer. Alternatively, the invention enables the employer to instantly communicate with a candidate after performing a manual search of prospective candidates.

This application claims the benefit of provisional application No. 60/813,605 to Eliezer Portnoy, which was filed on Jun. 20, 2006.

### BACKGROUND OF THE INVENTION

1. Field of the Invention

This invention relates to systems and methods for matching employer's jobs with prospective candidates and brokering instant communication between the employer and the candidate.

2. Description of the Related Art

Current methods for providing employer/job candidate matching do not fully serve the needs of job candidates or employers in the low-wage job market. The low-wage job candidate currently has limited options for securing employment: referrals from acquaintances, newspaper classifieds, and placement agencies. These options are generally slow, time consuming, and localized, i.e. the prospective worker must accept the fact that his job will be in his current geography. Newspaper classifieds usually require knowledge of English and are often untimely; placement agencies are highly manual and can be costly to candidates and prospective employers; and opportunities from referrals are hard to come by.

These options also fall short of serving the employer's needs Current options for recruiting low-wage employees are difficult slow and expensive, requiring tremendous patience. Newspaper classifieds are slow to attract qualified candidates, word-of-mouth referrals are unreliable and may take several days or weeks to bring a response, and placement agencies generally do not have available workers standing by. In addition these processes do not provide a comprehensive matching service that allows the employer to specify a particular skill-set for potential candidates. In newspaper classifieds and word-of-mouth referrals, the employer may receive many responses from people who have different skills than those desired, requiring the employer to perform a manual review of responses to find qualified candidates and arrange meetings with each qualified candidate. This process can be expensive and time consuming for employers.

Related art includes numerous recruitment websites such as Monster.com and CareerBuilder.com that are geared towards the hiring of skilled or professional workers. On these websites, candidates post their resumes and employers can search through their resumes or post jobs for the employee candidates to search through. However, these websites do not have the same functionality as our web invention to service the low wage market. The inherent nature of the low-wage job market means that many candidates do not have frequent access to a computer, if at all, are not technologically inclined, or do not adequately speak or read English in order to utilize current on-line recruitment websites. This results in a limited number of low-wage workers available for employment from these sites and therefore the current websites do not provide an adequate model for implementing an online recruitment system for low-wage workers.

Callback systems and methods are also known in the telecommunications arts. These methods include automatically calling a recipient's work phone number, cell phone number, home phone number, and pager, etc, in succession, in an attempt to reach the recipient. Other systems and methods include a caller initiating a call, requesting a callback from the recipient if the recipient does not answer the call, and routing the callback once the recipient retrieves the callback request and elects to call the caller back. Although this invention utilizes a callback system it differs significantly from the prior art, as discussed below.

### BRIEF SUMMARY OF THE INVENTION

The Matching system described herein allows employers and job candidates to overcomes the challenges associated with the low-wage job market. Stated generally, exemplary embodiments of the present invent_comprise a method and system for employer-to-job candidate matching with the capability to initiate near real-time communications between matched employers and candidates. The invention allows employers and job candidates to interact with the system in the language of their choice and using a communication platform with which they are comfortable, including a website, telephone, email, fax, Short Messaging System (SMS) or Multimedia Messaging System (MMS) text message, or postal mail.

In an exemplary embodiment, employers and job candidates are connected through a plurality of interfaces. Candidates looking for a position enter their profile and skill-set through a web-based interface, the phone, email, fax, or postal mail. The Matching system stores the information amongst a list of potential job candidates in the database. Next, an employer may use either a web-based interface or a phone to specify criteria for job candidates for a particular employment opportunity. The system scans through the list of potential candidates in the database, matches candidates to the criteria specified by the employer, and initiates an outbound telephone, email, fax, or text message communication to the job candidate notifying them of the potential opportunity. If the candidate is interested in the position, the system brokers a communication between the candidate and the employer by telephone, email, fax, or text messaging, depending on the method of communication the employer requested.

Exemplary embodiments of the invention allow employers to End suitable candidates in a matter of hours, not days, and be placed in immediate communication with matching candidates, for example, via telephone. In addition, the invention greatly increases the relevance of responses by matching candidates through a search algorithm based on specific criteria and geographic proximity. Utilizing exemplary embodiments of the instant invention, only relevant, responses are received by the employer. The system is also closed ended, so only communications brokered by the Matching system occur. This allows the employer to specify the number of responses the employer would like to receive.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates one embodiment of a computing device that can be used to practice aspects of the exemplary embodiment;

FIG. 2 illustrates an alternative embodiment of a computing device that can be used to practice aspects of the exemplary embodiment;

FIG. 3 is a system diagram of the Matching system according to one embodiment of the invention;

FIG. 4 is an overall logic flow diagram of the Matching system as applied to employer-to-job candidate matching, according to one embodiment of the invention;

FIG. 5 describes the job search logic flow, according to one embodiment of the invention,

FIG. 6 is an overall logic flow diagram of the Matching system as applied to buyer-to-seller matching, according to an alternative embodiment of the invention;

FIGS. 7A and 7B show the flow diagrams that illustrate the steps of an employer posting a job and the Matching and IVR systems automatically brokering instant communication between the employer and a matching candidate in one embodiment of the invention;

FIG. 8 show the logic flow diagrams that illustrate the steps for brokering instant communication between and employer and candidate during an employer's interactive search for job candidates in one embodiment of the invention;

FIG. 9 shows the logic flow diagram that illustrates the steps of a candidate performing a job search, in one embodiment of the invention;

FIG. 10 shows the logic flow diagram that illustrates the steps of a candidate performing a job search, in one embodiment of the invention, namely performing a search and making contact with an employer solely through the use of a telephone connection to the IVR system and Matching system; and

FIG. 11 shows the logic flow diagram that illustrates the steps of the Matching system and IVR system confirming whether a candidate has obtained employment, in one embodiment of the invention;

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Glossary

The following terms are defined below in order to allow for a better understanding of embodiments of the present invention. However, the terms are not meant to be limited to the definitions provided below, and may be understood further from the descriptions provided throughout, as well as in light of ordinary definitions known to those of ordinary skill in the art.

‘Computer’ or “computing device” broadly refers to any kind of device which receives input data, processes that data through computer instructions in a program, and generates output data. Such computer can be a hand-held device, laptop or notebook computer, desktop computer, minicomputer, mainframe, server, cell phone, personal digital assistant, other device, or any combination thereof.

‘Connected’ refers to a physical or wireless connection between two computing devices permitting communication of data. Two devices can be connected directly together or indirectly through one or more intermediate elements, through connection media that permits communication of data or a signal from one device to the other. Connection media includes wire, optical fiber, or wireless transmission, for example.

‘Server’ can refer alternatively to a computing device or a program executing on one or more computing devices, which accepts request data from other computing devices or “client” applications, processes the data through a set of computer instructions in the program, and returns the resulting processed data to the requesting computing device or client application Common servers include web servers, email servers, file servers, database servers, and network servers.

‘Database’ is any device or program capable of storing nonvolatile data, including magnetic tape, magnetic disk drive such as floppy disk or hard disk, optical storage media such as compact disc (CD) or digital versatile disc (DVD), FLASH memory, quantum memory device, and any other device that can be used to store data in machine readable form.

‘IVR’ means interactive voice response, which is a telephony technology in which a person uses a touch-tone telephone to interact with a server and database to acquire information from, or enter data into the database.

As will be appreciated by one skilled in the art, the exemplary embodiment may be implemented as a method, a data processing system, or a computer program product. Accordingly, the exemplary embodiment may take the form of an entirely hardware embodiment, an entirely software embodiment, or an embodiment combining software and hardware aspects. Furthermore, implementations of the exemplary embodiment may take the form of a computer program product on a computer-readable storage medium having computer-readable program instructions (e.g., computer software) embodied in the storage medium. More particularly, implementations of the exemplary embodiments may take the form of web-implemented computer software. Any suitable computer-readable storage medium may be utilized including hard disks, CD-ROMs, optical storage devices, or magnetic storage devices.

The exemplary embodiments according to the present invention are described below with reference to block diagrams and flowchart illustrations of methods, apparatuses (i.e., systems) and computer program products according to an embodiment of the invention. It will be understood that each block of the block diagrams and flowchart illustrations, and combinations of blocks in the block; diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

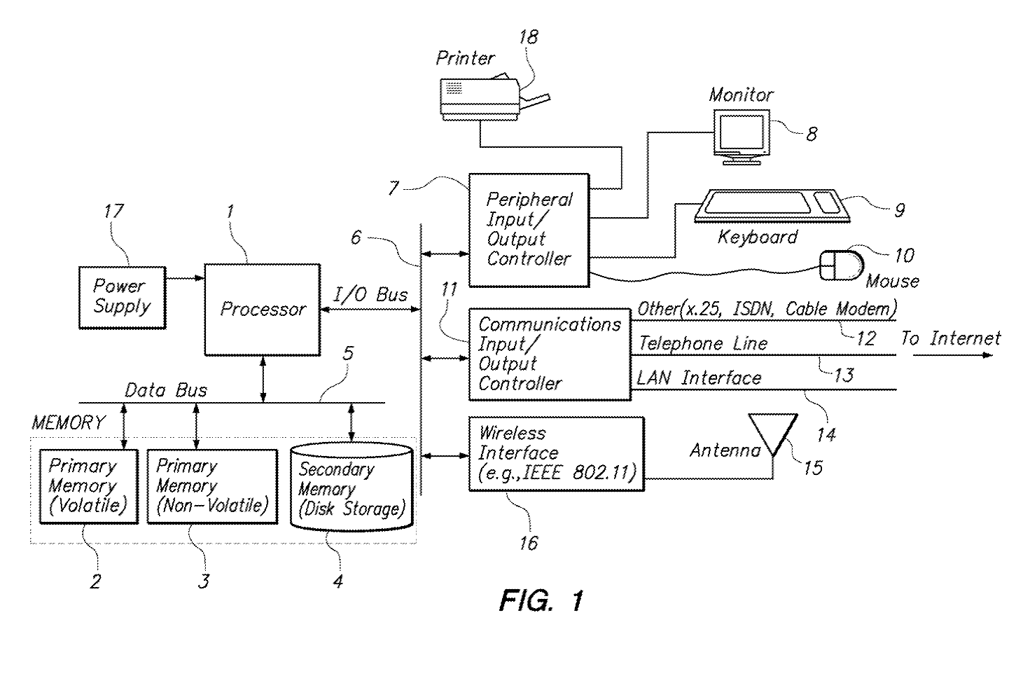

In the exemplary embodiments referenced herein, a “computer” or “computing device” may be referenced. Such computer may be, for example, a mainframe, desktop, notebook or laptop, a hand held device such as a data acquisition and storage device, or it may be a processing device embodied within another apparatus such as, for example, a set top box for a television system or a wireless telephone. In some instances the computer may be a “dumb” terminal used to access data or processors over a network. Turning to FIG. 1, one embodiment of a computing device is illustrated that can be used to practice aspects of the exemplary embodiment. In FIG. 1, a processor 1, such as a microprocessor, is used to execute software instructions for carrying out the defined steps. The processor receives power from a power supply 17 that also provides power to the other components as necessary. The processor 1 communicates using a data bus 5 that is typically 16 or 32 bits wide (e.g., in parallel). The data bus 5 is used to convey data and program instructions, typically, between the processor and memory. In the present embodiment, memory can be considered primary memory 2 that is RAM or other forms which retain the contents only during operation, or it may be non-volatile 3, such as ROM, EPROM, EEPROM, FLASH, or other types of memory that retain the memory contents at all times. The memory could also be secondary memory 4 such as disk storage, that stores large amount of data. The secondary memory may be a floppy disk, hard disk, compact disk, DVD, or any other type of mass storage type known to those skilled in the computer arts. In some embodiments, the disk storage may communicate with the processor using an I/O bus 6 instead or a dedicated bus (not shown).

The processor 1 also communicates with various peripherals or external devices using an I/O bus 6. In the present embodiment, a peripheral I/O controller 7 is used to provide standard interfaces, such as RS-232, RS-422, DIN, USB, or other interfaces as appropriate to interface various input/output devices. Typical input/output devices include local printers 18, a monitor 8, a keyboard 9, and a mouse 10 or other typical pointing devices (e.g., rollerball, trackpad, joystick, etc. not shown).

The processor 1 typically also communicates using a communications I/O controller 11 with external communication networks, and may use a variety of interfaces such as data communication oriented protocols 12 such as X.25, ISDN, DSL, cable modems, etc. The communications controller 11 may also incorporate a modem (not shown) for interfacing and communicating with a standard telephone line 13. Finally, the communications I/O controller may incorporate an Ethernet interface 14 for communicating over a LAN. Any of these interfaces may be used to access a wide area network such as the Internet, intranets, LANs, or other data communication facilities.

Finally, the processor 1 may communicate with a wireless interface 16 that is operatively connected to an antenna 15 for communicating wirelessly with another device, using for example, one of the IEEE 802.11 protocols, 802.15.4 protocol, or standard 3G wireless telecommunications protocols, such as CDMA2000 1x EV-DO, GPRS, W-CDMA, or other protocol.

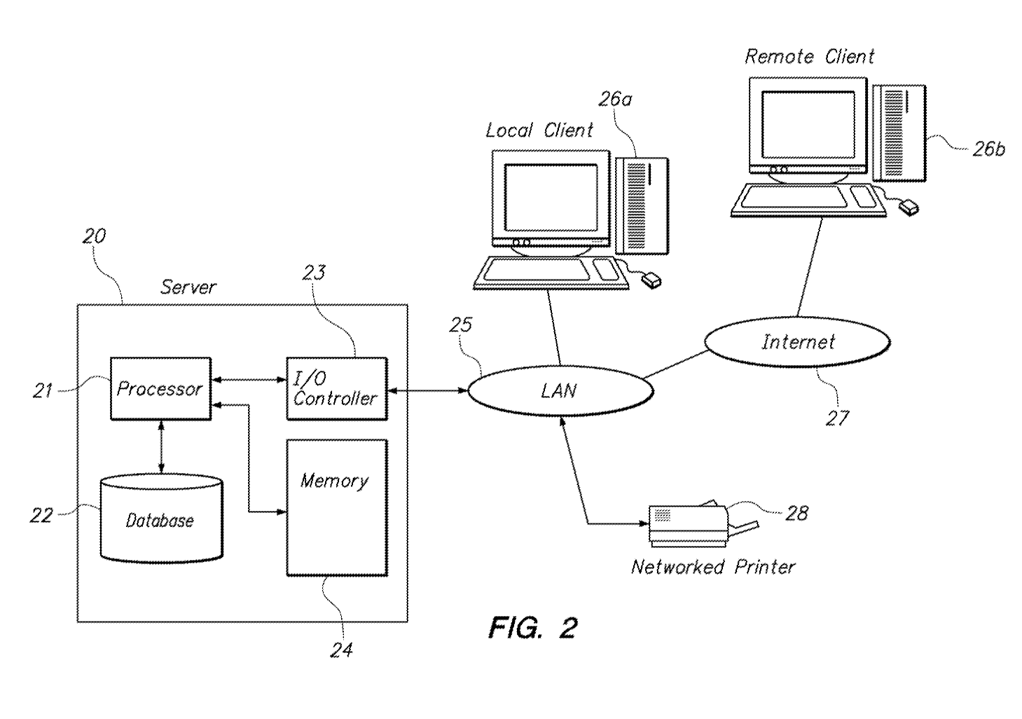

An alternative embodiment of a processing system that may be used is shown in FIG. 2. In this embodiment, a distributed communication and processing architecture is shown involving a server 20 communicating with either a local client computer 26a or a remote client computer 26b. The server 20 typically comprises a processor 21 that communicates with a database 22, which can be viewed as a form of secondary memory, as well as primary memory 24. The processor also communicates with external devices using an I/O controller 23 that typically interfaces with a LAN 25. The LAN may provide local connectivity to a networked printer 28 and the local client computer 26a. These may be located in the same facility as the server, though not necessarily in the same room. Communication with remote devices typically is accomplished by routing data from the LAN 25 over a communications facility to a wide area network 27, such as the Internet. A remote client computer 26b may execute a web browser, so that the remote client 26b may interact with the server as required by transmitted data through the wide area network 27, over the LAN 25, and to the server 20.

Those skilled in the art of data networking will realize that many other alternatives and architectures are possible and can be used to practice the exemplary embodiments. The embodiments illustrated in FIG. 1 and FIG. 2 can be modified in different ways and be within the scope of the present invention as claimed.

### DESCRIPTION OF THE EXEMPLARY EMBODIMENTS

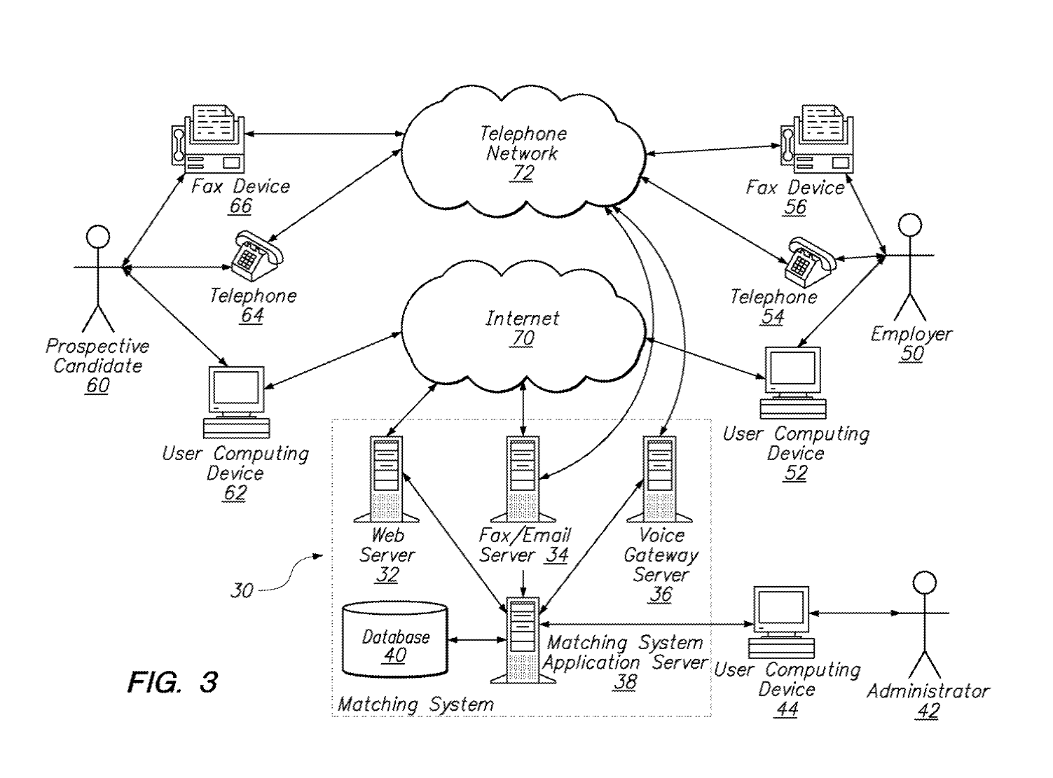

FIG. 3 illustrates a system diagram of the Matching system 30 in one embodiment of the invention. Prospective candidates 60 and employers 50 can interact with the system through a variety of communication methods, including, for example, a website provided by a web server 32 accessed via the Internet 70 by a web browser running on a user computing device 62, 52; an interactive voice response (IVR) system provided by a voice gateway server 36 accessed via a telephone 64, 54, email, or text message, sent or received by a user computing device 62, 52 via the Internet 70 processed through an email and text messaging server 34; or fax sent or received via a user's fax device 66, 56 processed through a fax server 34. Each server providing the described communication methods is operatively connected to the Matching system application server 38, which provides the functionality and control of user interactions. The Matching system application server is further connected to a database 40 which provides storage of and access to data comprising prospective candidates, employers, job opportunities, candidate/employer communications, and configuration data.

In one embodiment, the web server 32, fax server 34, email server 34, voice gateway server 36, Matching system application server 38, and database 40 may all execute on a single computing device. In an alternative embodiment, the servers and database may reside on one or more computing devices operatively connected to and controlled by the Matching system application server, and in further embodiments, the functionality of one or more servers may be provided by third party providers that connect to the Matching system application server via the Internet. As may be appreciated by one having ordinary skill in the art, in one embodiment of the invention the Matching system may comprise an application server executing on a computing device connected to the Internet that also hosts a web server and email server, with fax services provided by a third party provider such as eFax® connected to the Matching system application server via the Internet utilizing the SMTP protocol, and voice gateway services provided by another third party provider such as Voxeo connected to the Matching server via the Internet utilizing the VoiceXML protocol.

In one embodiment of the invention, incoming email and faxes supporting prospective candidate or employer interactions would be received through the email server 34 and fax server 34 respectively and processed automatically by the Matching system application server 38. In another embodiment, incoming email and faxes would be viewed by administrative personnel 42 through a user computing device 44 connected to the email and fax servers, the administrator then transcribing the information contained therein into the Matching system via a user computing device 44 operatively connected to the Matching system application server 38.

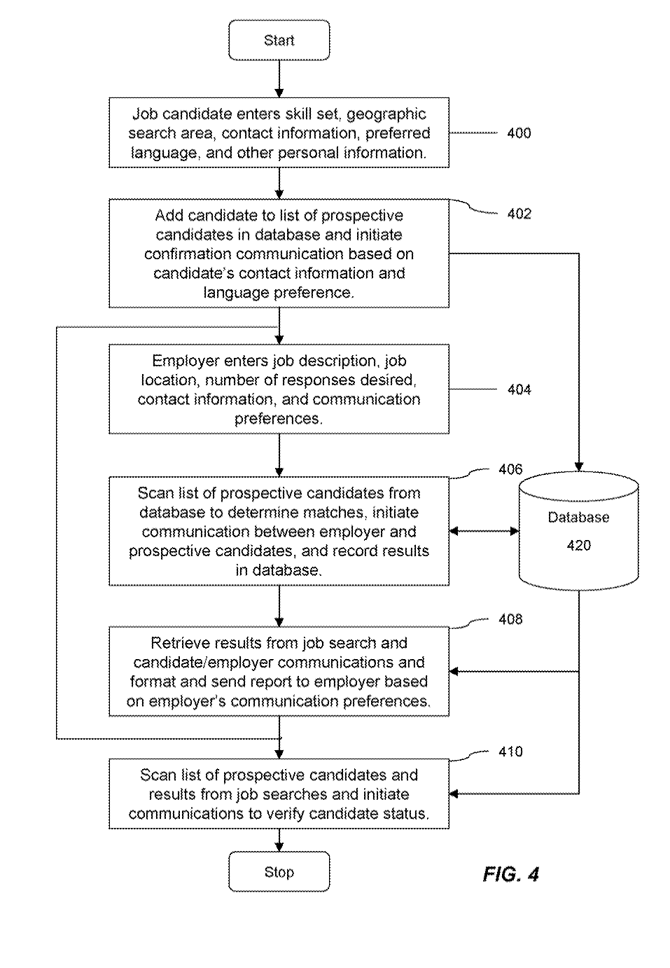

FIG. 4 describes the general processing logic flow of one embodiment of the Matching system. At step 400, one or more job candidates contact the system to register their interest in obtaining employment. As described above, this contact can be established using a variety of communication methods, including through a website, by telephone, fax, email, or postal mail, and is performed in the language, of choice by the candidate. The job candidate specifies information that may include:
language preference for communication, such as English, Spanish, or Portuguese;
their job criteria and skill-set based on a pre-configured set of criteria, such as level of English spoken, type of employment sought (e.g. full-time, part-time, contract), previous experiences, list of references, licenses and special skills, and level of education;
a geographic description of the area in which employment is sought, such as a zip code;
contact information and communication preferences, such as name, phone number, fax number, email address, postal address, preferred method of communication (e.g. telephone, fax, email), preferred times to be contacted, etc.; and
other personal information such as a picture for viewing by potential employers.
   The Matching system receives the information 402 and includes the job candidate in a list of prospective candidates in the database 420. The system then initiates a communication to the job candidate to confirm their information has been received. The confirmation message is formatted in the language specified by the candidate and is transmitted, for example, by phone, email, or fax based on the candidates specified communication preferences.

At step 404, employers contact the system to initiate a search for potential employees. As before, this contact can be made through a variety of communication methods and in the language of choice of the employer. The employer specifies information that may include:
a description of the job to filled;
the job criteria and skill-set desired based on pre-configured criteria;
the geographic location of the job, such as a zip code;
the number of responses from job candidates the employer desires; and
contact information and communication preferences.
   The Matching system performs a job search 406 by scanning the list of prospective candidates in the database 420 and algorithmically matching the candidate's skill-set and geographical search area with the desired skill-set and job location specified by the employer. When a matching candidate is identified, the system initiates a communication to the candidate based on the candidate's contact information and language preferences with a description of the potential job Depending on the communication method chosen, the candidate will be given the opportunity to immediately contact the employer to further discuss the potential job.

In one embodiment of the invention, matching candidates are contacted via telephone by the Matching system utilizing an IVR system, which audibly provides the job information specified by the employer in the candidate's preferred language, and gives a menu of choices for responding. If the candidate is not interested in the job, she may choose the corresponding menu option by voice or telephone keypad or by simply hanging up. If the candidate is interested, she may choose to be immediately connected to the employer via telephone to further discuss the opportunity, if the candidate does not wish to receive any future calls from the Matching system, she may choose that option as well.

The Matching system records the candidate's response in the database for each matching candidate, and the process is repeated until the number of positive responses specified by the employer is reached if so specified by the employer. After the number of positive responses has been reached or all potential candidates have been contacted, the system initiates a communication to the employer 408 summarizing the job search process results including the contact information, skill-set, and any other personal information available in the database 420 for each candidate who responded with an interest in the job. The summary message may be sent to the employer by email, fax or telephone based on the employer's communication preferences and the summary information is stored on the server to be viewed by the employer at his convenience via a web interface. In one embodiment, after a configured amount of time, the Matching system initiates a communication to each matched candidate that responded positively to the job opportunity 410 in order to determine whether the candidate was employed by the employer. This communication is performed based on the candidate's contact information and language preferences. In one embodiment of the invention, the candidate is contacted via telephone by the Matching system utilizing an IVR system, and asked in the language of her choice if she was hired for the position. If the candidate responds positively either by voice or by telephone keypad, the job placement is recorded in the database and the candidate is taken out of the list of potential job candidates for subsequent job searches.

As an additional verification of the eligibility of candidates in the database 420, in one embodiment of the invention, the Matching system is configured to temporarily remove from the list of prospective candidates any candidate matched in a configured number of job searches who did not respond positively to any of the job opportunities. A communication is initiated to the candidate based on the candidate's contact information and language preferences. In one embodiment of the invention, the candidate is contacted via telephone by the Matching system utilizing an IVR system, and asked in the language of her choice if she wishes to continue to be listed as a prospective candidate for jobs. If the candidate responds positively, either by voice or by telephone keypad, the candidate is placed back in the list of potential job candidates for subsequent job searches. If the candidate responds negatively, then she is permanently removed from the list. If the number is not answered, then an administrator is notified by the system to manually verify the eligibility of the candidate.

In order to provide the employer with candidates that best match the desired criteria while eliminating complex and exhaustive manual review by the employer, the Matching system relies on a search algorithm that matches pre-configured job criteria as well as geographic proximity of the employment opportunity to the candidates desired job location. In one embodiment of the invention, pre-configured job criteria may include level of English spoken, type of employment sought (e.g. full-time, part-time, contract), previous experience, level of education, etc. The Employer can specify a required level for each criterion, such as minimal understanding of spoken English, minimum full-time employment, at least four (4) years of previous experience in the field of employment, and at least a high-school diploma or equivalent in education. The Employer may also specify which criteria are mandatory for a match and which are optional as well as specify the order of importance of each optional criterion. In one embodiment of the invention, the Matching system determines the geographical proximity of the job location to the candidates desired area by calculating the distance between the geographic center of the area defined by the zip code (the zip code centroid) specified by the employer and the zip code centroid specified by the candidate.

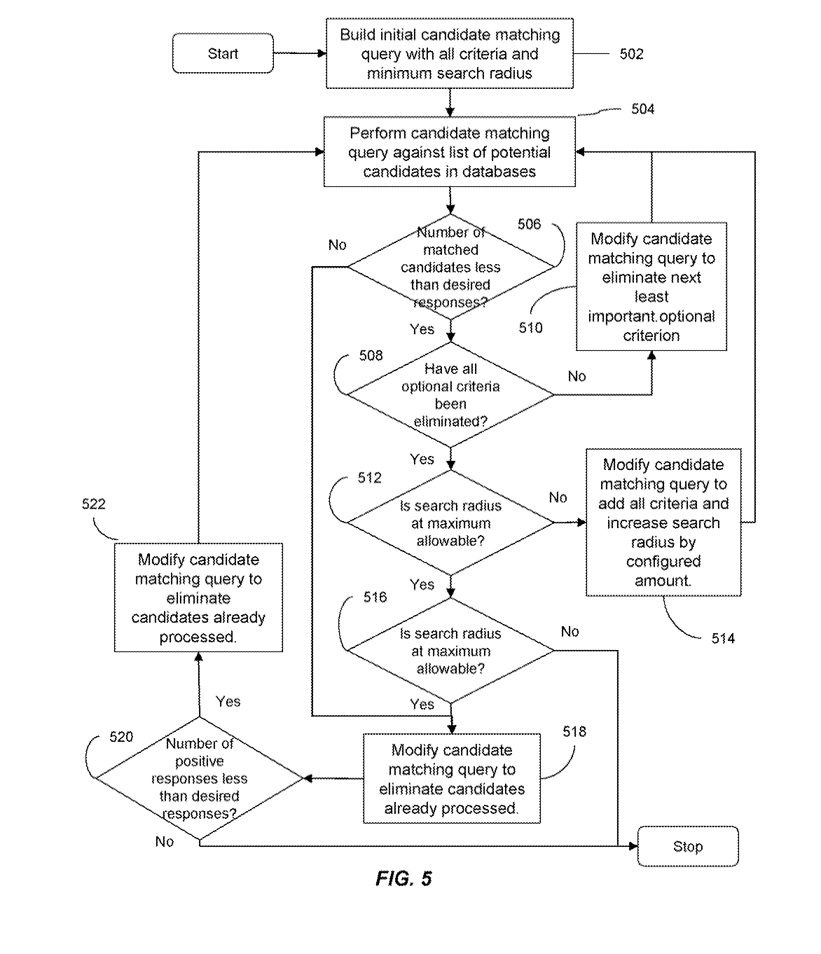

FIG. 5 further describes the job search logic flow in one embodiment of the invention. Initially, the search query of the list of potential candidates is created using all mandatory and optional criteria and a configured minimum search radius around the zip code centroid specified by the employer 502. The query is performed and the number of matching candidates is determined 504. If the number of matches is less than the number of responses desired by the employer 506, the searched is broadened by eliminating the least important optional criteria from the search query 510 and repeating the search. This is done until the number of matches equals or exceeds the number of desired responses 506 or until all optional criteria have been eliminated from the search query 508. If all optional criteria have been eliminated but the number of matches is still less than the number of desired responses, the search radius is increased by a configured amount 514 and the search process is performed again starting with all criteria and eliminating optional criteria or increasing the search radius as needed until the number of matching candidates equals or exceeds the number of desired responses 506 or the search radius exceeds a pre-configured maximum 512.

Once the number of matching candidates equals or exceeds the number of desired responses 506 or the search of the list of potential candidates is exhausted, the Matching system proceeds to contact each matching candidate by creating a message describing the job information specified by the employer in the candidate's preferred language and initiating a communication with the candidate based on the candidates specified communication preferences 518. In one embodiment of the invention, matching candidates are contacted via telephone by the Matching system utilizing an IVR system. The system queues communications to a configured number of matching candidates in the IVR system queue, which initiates a new call to a matched candidate on a periodic time basis, e.g. every two minutes. Once the configured number of matching candidates has been contacted, the system evaluates the number of positive responses received by the employer from the candidates. If the number of positive responses is less than the desired number specified by the employer, communications are queued for the next configured number of matching candidates until the number of desired positive responses is received or the list of matching candidates is exhausted.

If the list of matching candidates is contacted without receiving the desired number of positive responses 520, the search process is continued from the point previously reached to further widen the search query to return additional candidates 522. This process is repeated until the employer has received the number of positive responses from qualified candidates desired or the list of matching potential candidates has been exhausted.

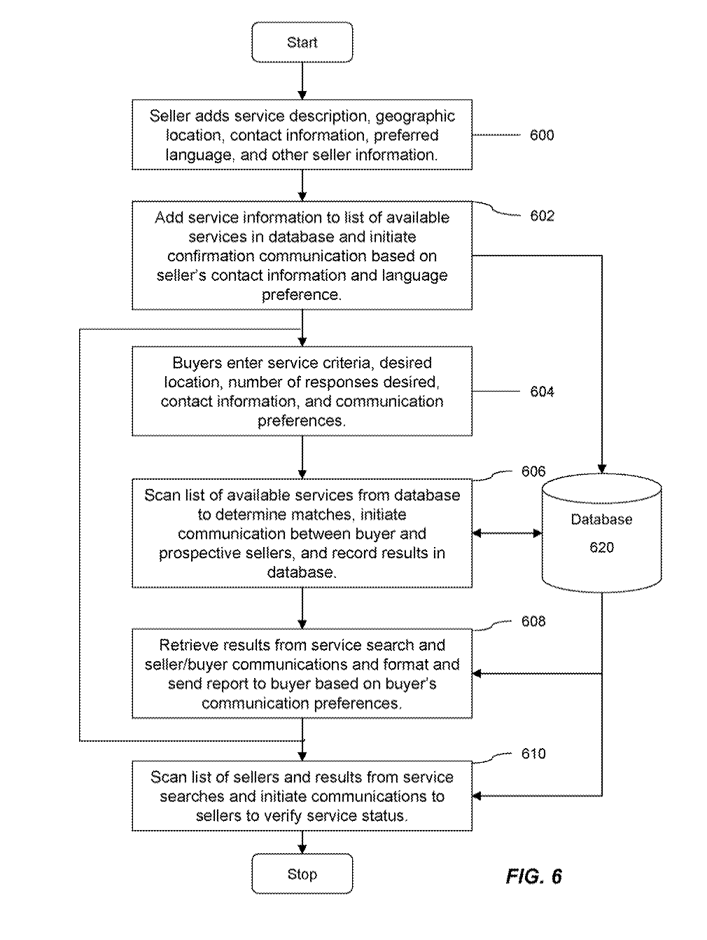

In an alternative embodiment of the invention, the Matching system as described can be configured to serve markets other than low-wage job market. FIG. 6 describes the overall logic flow of the Matching system as applied to the matching of buyers to sellers of generic products or services. First, one or more sellers contact the system to register their products or services for sale 600. The seller provides a description of the products and services using criteria configured in the system, the geographic area served, a preferred language for communications, contact information and communication preferences, and other seller information as required. The Matching system receives the information 602 and enters the seller's products or services in a list of available products or services in the database 620. The system then initiates a communication to the seller to confirm their information has been received. The confirmation message is formatted in the language specified by the seller and is transmitted, for example, by phone, email, or fax based on the seller's specified communication preferences.

Next, buyers contact the system to initiate a search for products or services 604, specifying a description of the products or services desired, the criteria for the products or services desired, the geographic location in which products or services are desired, the number of responses from prospective sellers desired; and their contact information and communication preferences. The Matching system performs a search 606 by scanning the list of available products or services in the database 620 and algorithmically matching the seller's products or services to the criteria specified by the buyer. When a matching seller is identified, the system initiates a communication to the seller based on the seller's contact information and language preferences with the description of the products and services desired by the buyer. As described above, depending on the communication method chosen, the seller will be given the opportunity to immediately contact the buyer to further discuss the buyer's needs for the products and services.

The Matching system records the seller's response in the database for each matching seller, and the process is repeated until the number of positive responses specified by the buyer is reached. After the number of positive responses has been reached or the entire list of available products or services has been scanned, the system initiates a communication to the potential buyer 608 summarizing the search process results including the contact information, criteria, and any other seller information available in the database 620 for each seller who responded positively to the buyers interest. The summary message is sent to the buyer, for example, by email, fax or telephone based on the buyer's communication preferences and the summary information can be viewed by the buyer through the website. A configured amount of time after each search, the Matching system initiates a communication to each matched seller 510 that responded positively to the buyer's interests in order to determine whether the seller is interested in receiving future contacts for their products and services from the system.

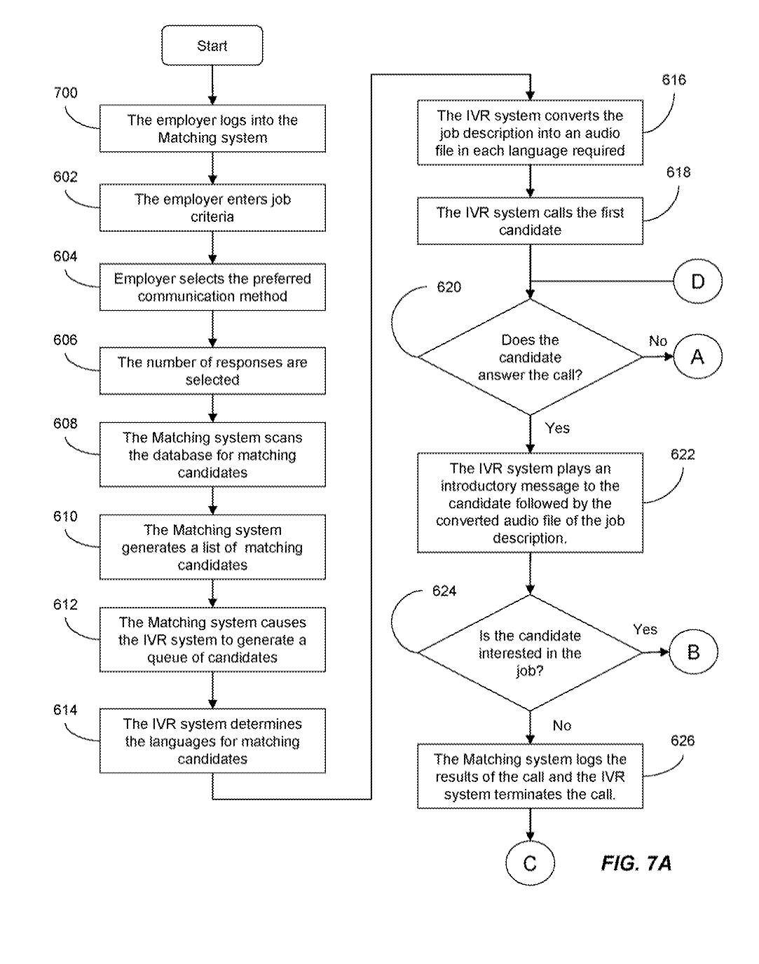

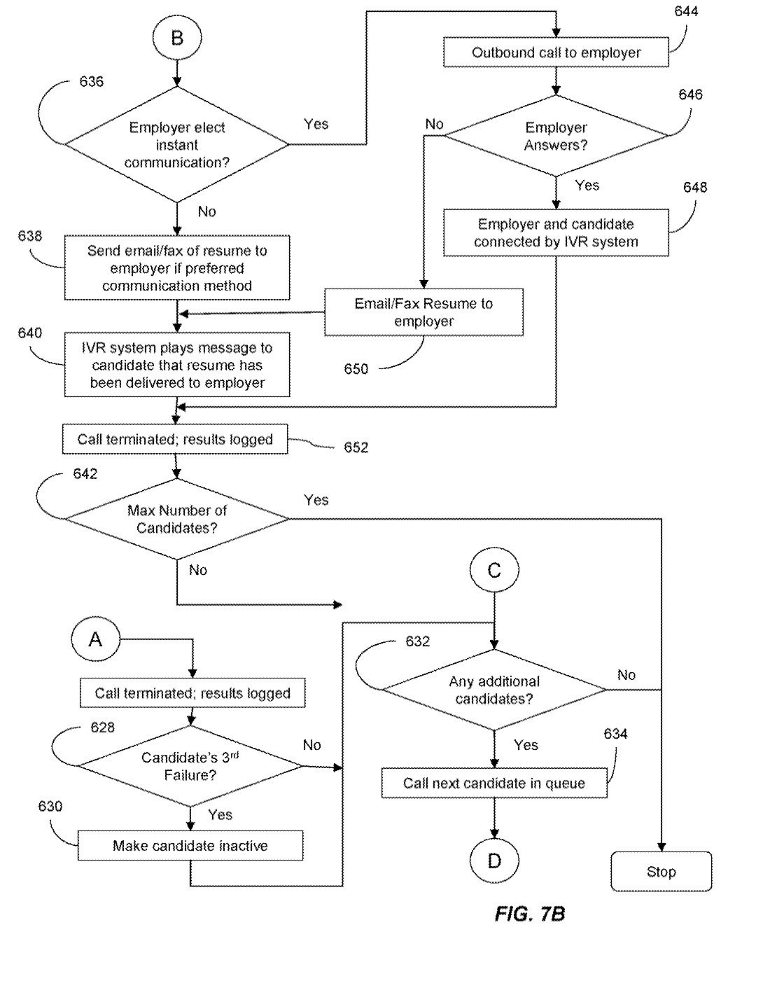

FIGS. 7A and 7B are flow diagrams that illustrate the steps of an employer posting a job and the Matching and IVR systems automatically brokering instant communication between the employer and a matching candidate in one embodiment of the invention. The first operation, represented by the flow diagram 700, is the employer begins by logging info the Matching server, where the employer's name, address and other identifying information is stored. The employer enters a job description, represented by the flow diagram 702, including the location of the job, the responsibilities and task to be performed, and the requirements and desired skills for a candidate applying for the job, which information is stored and posted by the Matching system on the website for viewing by candidates and for comparison with candidate profiles. The employer then selects the preferred method of communication from a candidate interested in a job description, represented by the flow diagram 704, which method may be by telephone, facsimile, email, instant messaging, or any other communication method. In the preferred embodiment, the employer may request resumes of matching candidates be faxed to the employer at the fax address provided or emailed to the employer at the email address provided. On the other hand, the employer may elect to interactively communicate with the candidate by telephone.

Once the employer has entered all mandatory job information and all desired qualifications, and has selected the preferred communication method, the employer may then select the maximum number of matching candidates the employer wishes to receive, represented by the flow diagram 706. Alternatively, the Matching system may be configured to provide a predetermined number of matching candidates. The Matching system begins querying the database of candidates actively seeking employment, represented by the flow diagram 708 to determine if any candidate profile, matches the requirements of the employer. If any candidate profile matches the requirements entered by the employer, a list of matching candidates is generated by the Matching system, represented by the flow diagram 710.

If the employer has elected to receive information on matching candidates by email or by facsimile, according to step 704, the Matching system aggregates the profiles of each candidate on the list and creates an outgoing communication for delivery to the employer, by either an outgoing facsimile or an email, as the employer has selected. On the other hand, if the employer has elected to communicate with the candidate by telephone, the Matching system queues communications to candidates and employers in an outbound call queue, and any outgoing communication is formatted into a VoiceXML format file specifying the location of audio, voice, or text content of the communication as well as processing logic for the processing of user responses, represented by the flow diagram 712. The Matching system queues communications to a configured number of matching candidates in the IVR system queue, which initiates a new call to a matched candidate on a periodic time basis, e.g. every two minutes.

The Matching system determines the language preference for each matching candidate in the queue according to the profile of the candidate stored in the database, and determines which languages are necessary to communicate with each candidate, represented by the flow diagram 714. The Matching system then directs the IVR system to convert the communication, where the communication includes the job description and skills desired, into an audio file where there is one audio file for each language necessary to communicate with each candidate in the queue, represented by the flow diagram 716. In step 718, the IVR system places a telephone call to the first candidate in the queue.

At decision box 720, the IVR system determines if the call to the candidate was answered. If the candidate contacted does not answer the telephone call, the IVR system returns the results of the communication in a VoiceXML file, which is processed by the Matching system and the results are recorded in the database, represented by the flow diagram 728 of FIG. 6B Continuing to decision box 730, the Matching system determines if the candidate has not answered a telephone from the IVR system on three consecutive attempts, which indicates the candidate is no longer available for new employment opportunities. If the same candidate has not answered the phone in three consecutive attempts, the Matching system removes candidate profile from any further participation in job searches by employers, represented by the flow diagram 732. The IVR system determines if there are any additional candidates in the queue, represented by decision box 754. If there are no additional candidates remaining in the telephone queue, the IVR system process terminates. If there are additional candidates remaining in the telephone queue, the IVR system initiates a telephone call to the next candidate in the queue, represented by the flow diagram 756. The process flows back to decision box 720 where the IVR system determines if the next candidate answered the telephone call.

If the candidate answers the telephone call, the IVR system plays the audio file in the language preference of the candidate, represented by the flow diagram 722, stating the reason for the call, playing the audio file of the job description, and a request for the candidate to express his interest in the job. The candidate expresses his interest, or lack of interest as the case may be, by either voice or pressing a button on the telephone, represented by decision box 724. If the candidate is not interested in the job, the results of the telephone call are logged by the Matching system and the telephone call with the candidate is terminated, represented by the flow diagram 726. The IVR system determines if there are any additional candidates in the queue, represented by decision box 754. If there are no additional candidates remaining in the telephone queue, the IVR system process terminates. If there are additional candidates remaining in the telephone queue, the IVR system initiates a telephone call to the next candidate in the queue, represented by the flow diagram 756. The process flows back to decision box 720 where the IVR system determines if the next candidate answered the telephone call.

Going back to decision box 724, if the candidate is interested in the job, the process flows to decision box 736 where the Matching system determines the method of communication selected by the employer in step 704. If the employer has elected to receive communication from an interested candidate by email or fax, the profile of the candidate contained in the Matching system database is routed to the employer's email address or faxed to the employer, represented by the flow diagram 738. The IVR system plays a status message to the candidate informing the candidate that his profile has been forwarded to the employer, represented by the flow diagram 740. The IVR system returns the results of the communication in a VoiceXML file, which is processed by the Matching system and the results recorded in the database, represented by the flow diagram 752 of FIG. 7B, and the telephone call with the candidate is terminated. Next, in decision box 742, the Matching server determines if the maximum number of candidates to be contacted has been reached. If the maximum number of candidates has been reached, the IVR system processes terminate.

If the maximum number of candidates has not been reached, the process flows to decision box 754 where the IVR system determines if there are any more candidates remaining in the telephone queue to be contacted. If there no additional candidates remaining in the telephone queue, the IVR system process terminates. If there are additional candidates remaining in the telephone queue, the IVR system initiates a telephone call to the next candidate in the queue, represented by the flow diagram 756. The process flows back to decision box 720 where the IVR system determines if the next candidate answered the telephone call.

Going back to decision box 736, if after the candidate has expressed interest in the job, and the employer has elected to communicate with the candidate by telephone, the IVR system initiates an outbound telephone call to the employer, represented by the flow diagram 744. In decision box 746, the IVR system determines if the employer answered the telephone call. If the employer does not answer the telephone call from the IVR system, the Matching system delivers the interested candidate's resume to the employer by email or fax, represented by the flow diagram 750. The IVR system plays a message to the candidate informing the candidate that his resume has been forwarded to the employer, represented by the flow diagram 740. The IVR system returns the results of the communication in a VoiceXML file, which is processed by the Matching system and the results recorded in the database, represented by the flow diagram 752 of FIG. 7B, and the telephone call with the candidate is terminated. Next, in decision box 742, the Matching server determines if the maximum number of candidates to be contacted has been reached. If the maximum number of candidates has been reached, the IVR system processes terminate.

Going back to decision box 746, if the employer answers the IVR system telephone call, the employer and the candidate are instantly connected telephonically by the IVR system where they may communicate interactively, including discussing the job opportunity and the candidate's qualifications, represented by the flow diagram 748. Once the employer and candidate have terminated their call, the IVR system returns the results of the communication in a VoiceXML file, which is processed by the Matching system and the results recorded in the database, represented by the flow diagram 752 of FIG. 7B. Next, in decision box 742, the Matching server determines if the maximum number of candidates to be contacted has been reached. If the maximum number of candidates has been reached, the IVR system processes terminate.

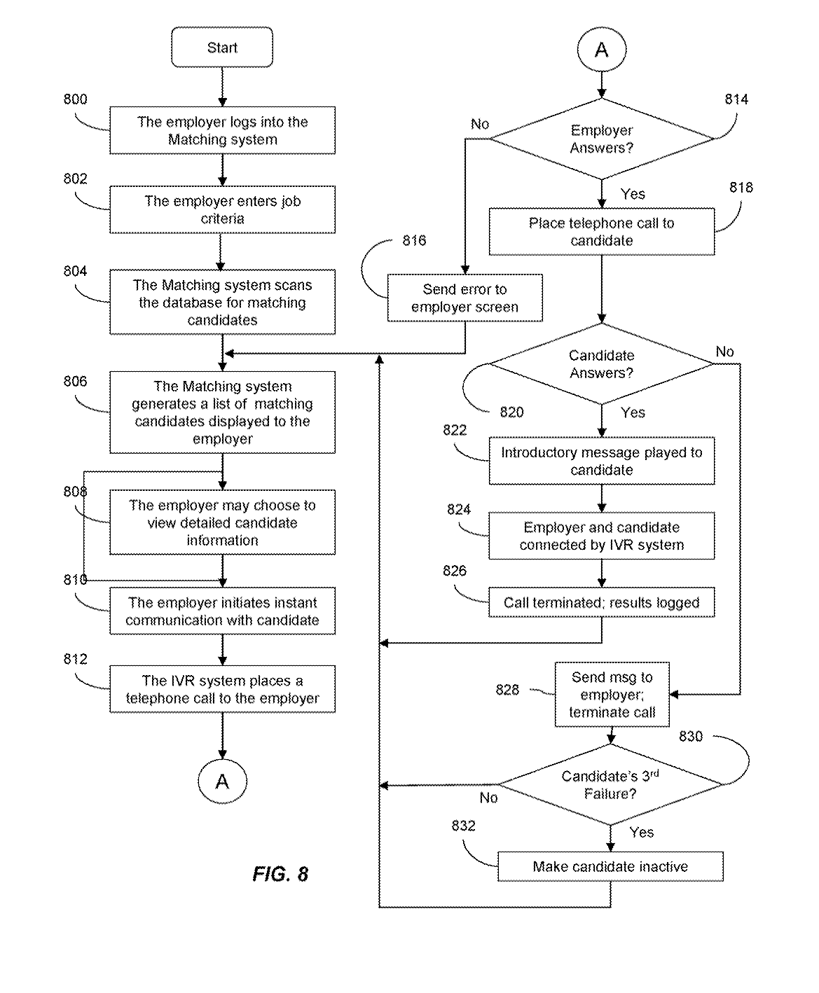

FIG. 8 are flow diagrams that illustrate the steps for brokering instant communication between and employer and candidate during an employer's interactive search on the website for job candidates in the database, in one embodiment of the invention. The first operation, represented by the flow diagram 800, is the employer begins by logging into the Matching server via an interactive website, where the employer's name, address and other identifying information is stored. The employer enters a job description, represented by the flow diagram 802, including the location of the job, the responsibilities and task to be performed, and the requirements and desired skills for a candidate applying for the job, which information is temporarily stored by the Matching system for comparison with candidate profiles. The Matching system begins querying the database of candidates actively seeking employment, represented by the flow diagram 804 to determine if any candidate profile matches the requirements of the employer. If any candidate profile matches the requirements entered by an employer, a list of matching candidates is generated by the Matching system and is displayed to the employer on the website, represented by the flow diagram 806. The employer may elect to view detailed information about a particular candidate by pressing a clickable button, represented by the flow diagram 808. From the detailed view of the candidate information, the employer may elect to initiate an instant communication with the candidate by clicking a button, represented by the flow diagram 810. In the alternative, from the list of matching candidates represented by flow diagram 808, the employer may also elect to initiate an instant communication with the candidate by pressing a clickable button.

If the employer does not wish to communicate with the candidate after reviewing the detailed information about a candidate, the employer can return to the list of matching candidates, in step 806. If the employer wishes to initiate instant communication with a candidate from either the list of matching candidates or the detailed view of a candidate, by clicking a button, the Matching system directs the IVR system to make an outbound telephone call to the employer, represented by the flow diagram 812. Mining to decision box 814, the IVR system determines if the employer answers the telephone call. If the employer does not answer, the IVR system instructs the Matching system to interactively display an error message to the employer, represented by the flow diagram 816. The employer may continue viewing the list of matching candidates in step 806 and proceed with initiating an instant communication once again, represented by the flow diagram 810.

Moving back to decision box 814, if the employer answers the telephone call from the IVR system, the IVR system then initiates an outbound call to the selected candidate, represented by the flow diagram 818. Moving to decision box 820, the IVR system determines if the candidate answers the telephone call.

If the candidate called does not answer the telephone call, the IVR system plays an audio message to the employer indicating the candidate did not answer the telephone and returns the results of the communication in a VoiceXML file, which is processed by the Matching system and the results recorded in the database, represented by the flow diagram 828. The process continues to decision box 830, where the Matching system determines if the candidate has not answered a telephone from the IVR system on three consecutive attempts, indicating the candidate is no longer available for new employment opportunities. If the same candidate has not answered the phone in three consecutive, attempts, the Matching system removes candidate profile from any further participation in job searches by employers, represented by the flow-diagram 832. The employer returns to step 806 where the employer may continue viewing the search result of matching candidates and may initiate instant communication with any of them. The employer may repeat this process until the employer has attempted to contact all desirable candidates or simply terminates the process.

Going back to decision box 820, if the candidate answers the telephone call, the IVR system plays an audio file in the language preference of the candidate according to the candidate's profile, stating the reason for the call, represented by the flow diagram 822. The employer and the candidate are instantly connected telephonically by the IVR system, where they may communicate interactively, including discussing the job opportunity and the candidate's qualifications, represented by the flow diagram 824. The employer and candidate may terminate the call at any time simply by hanging up. Once the employer and candidate have terminated their call the IVR system returns the results of the communication in a VoiceXML file, which is processed by the Matching system and the results recorded in the database, represented by the flow diagram 826. The employer may continue reviewing candidates by returning to the list of candidates, represented by the flow diagram 806, or terminate the process.

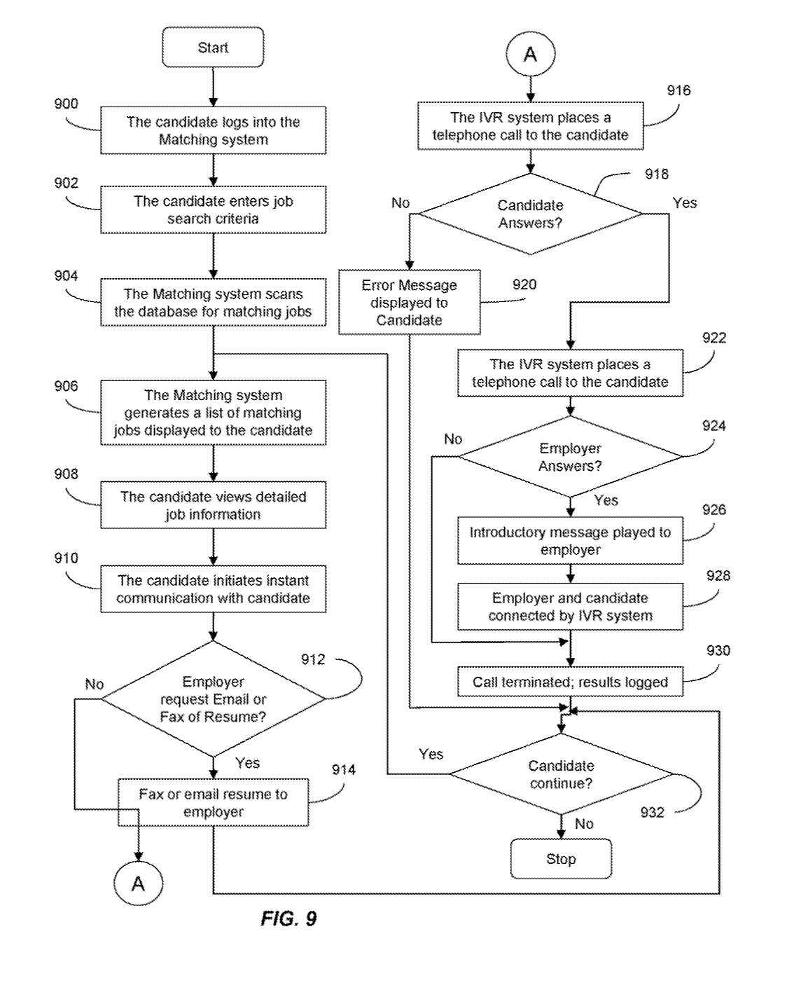

FIG. 9 is the flow diagram that illustrates the steps of a candidate performing a job search, in one embodiment of the invention. In this embodiment, the candidate searches the database for jobs matching the candidate's qualifications and skills, and initiates instant communication with the employer. The first operation, represented by the flow diagram 900, begins by the candidate logging into the Matching server, where the candidate's name, address and other identifying information is stored. The candidate enters mandatory and optional search criteria to search the job postings entered by prospective employers, represented by the flow diagram 902. The Matching system begins querying the database of open job opportunities, represented by the flow diagram 904 to determine if any job opportunities match the candidate's profile. A viewable list of job opportunities is generated by the Matching system, and displayed on the website to the candidate in the language of his choice, represented by the flow diagram 906. The candidate can then select a single job opportunity to review in detail, including the name of the employer, the location, the responsibilities, and the requirements for applying for the job, to determine whether the candidate meets the criteria requested by the employer, represented by the flow diagram 908. The candidate may then select to fake no action with the job opportunity and return to viewing the list in step 906 or view details of the next job opportunity on the list.

If the candidate wishes to contact the employer about the job opportunity, the candidate may press a clickable button to initiate communication with the employer, represented by the flow diagram 910. A predetermined communication method has been selected by the employer for any communication initiated by a candidate Moving to decision box 912, the Matching system determines if the employer has elected to receive a fax, email, or telephonic communication. If the employer has elected to receive a fax or email communication, the candidate's profile is faxed to the employer's fax number or emailed to the employer at the email address, both of which are contained in the employer's profile saved by the Matching system, represented by the flow diagram 914.

If rather than an email or fax communication, the employer has elected to receive a telephone communication from the candidate, the candidate may initiate the telephone communication. The Matching system instructs the IVR to make an outbound telephone call to the candidate at the telephone number provided in the candidate's profile, represented by the flow diagram 916. Moving to decision box 918, the IVR system determines if the candidate answers the phone. If the candidate fails to answer, the IVR system instructs the Matching system to route a notification error to the candidate's screen, represented by the flow diagram 920. The process then moves to decision box 932 to determine if the candidate wishes to continue with his search of job opportunities in the database. If the candidate wishes to end his search, the process is terminated. If the candidate wishes to continue searching, the process flows back to step 906 where the candidate is presented with the list of matching job opportunities.

Moving back to decision box 918, if the candidate answers the telephone call, the Matching system instructs the IVR system to make an outbound telephone call to the employer at the phone number provided in the employer's profile, represented by the flow diagram 922. The IVR system then determines if the employer answers the telephone call at decision box 924. If the employer does not answer the telephone call made by the Matching system, the process flows to decision box 930 where the telephone call to the candidate is terminated, and the IVR system returns the results of the communication in a VoiceXML file, which is processed by the Matching system and the results recorded in the database. The logic flow proceeds to decision box 932 where the candidate may choose to continue searching job opportunities.

Moving back to decision box 924, if the employer answers the phone, the IVR system plays an audio file informing the employer of the reason for the call, represented by the flow diagram 926. The employer and the candidate are instantly connected telephonically by the IVR system where they may communicate interactively, including discussion about the job opportunity and the candidate's qualifications, represented by the flow diagram 928, Once the employer and candidate have terminated their call by hanging up, the IVR system returns the results of the communication in a VoiceXML file, which is processed by the Matching system and the results recorded in the database, represented by the flow diagram 930. The logic proceeds to decision box 932 where the candidate is presented with the decision to continue searching jobs or terminate the search process. The candidate may continue searching the job database until all job opportunities have been exhausted, or the candidate may terminate the search at any time during the process.

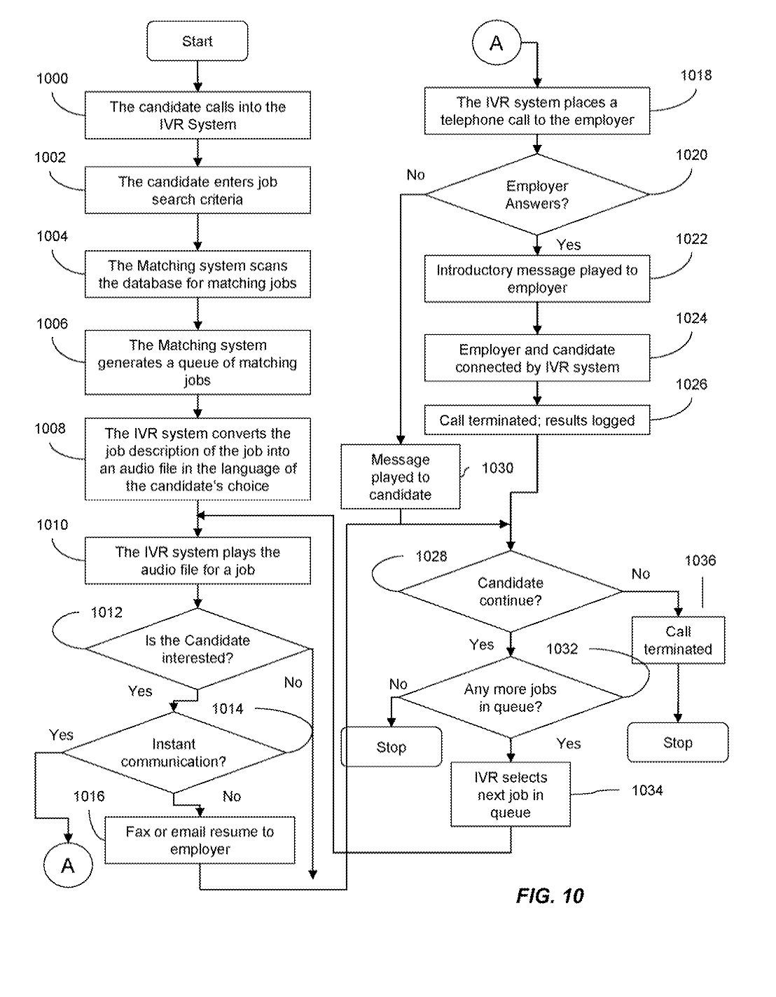

FIG. 10 is the flow diagram that illustrates the steps of a candidate performing a job search, in one embodiment of the invention, namely performing a search and making contact with an employer solely through the use of a telephone connection to the IVR system and Matching system. The first operation, represented by the flow diagram 1000, begins by the candidate logging into the Matching system via a telephone connection through the IVR system. By issuing voice responses or pressing buttons on the telephone in response to audio queries from the IVR system, the candidate can enter mandatory and optional search criteria in order to search the job database, represented by the flow diagram 1002. The IVR system converts the candidate's responses into VoiceXML files, which the Matching system uses to query the database of open job opportunities, represented by the flow diagram 1004 to determine if any job opportunities match the candidate's profile.

If any jobs match the candidate's qualifications, a list of each job is created, represented by the flow diagram 1006. The Matching system then directs the IVR system to convert the job description for each job on the list, including the employer, the location, the responsibilities, and the requirements for applying for the job, into an audio file in the language of the candidate's choice found in the candidate's profile, represented by the flow diagram 1008, and which communication includes the job description and skills desired. The IVR system queues the job descriptions and plays for the candidate the audio file for a job, represented by the flow diagram 1010. Moving to decision box 1012, the candidate must determine if he is interested in applying for the job. If the candidate is not interested in the job opportunity, the candidate is then given the option of proceeding to the next job on the list, represented by decision box 1028. If the candidate does not wish to continue, the IVR system terminates the call, represented by flow diagram 1036, and the process stops. If the candidate wishes to continue, the process flows to decision box 1032 where the IVR system determines if there are any more jobs in the queue. If there is an additional job description in the queue, the IVR system selects the next job in the queue, represented by flow diagram 1034, and proceeds to step 1010 where the IVR system plays the audio file for the candidate.

Going back to decision box 1012, if the candidate is interested in the job, the process flows to decision box 1014 where the IVR system determines the method of communication selected by the employer. If the employer has elected to receive a fax or email communication, the candidate's profile is faxed or emailed to the employer, represented by flow diagram 1016. The logic flows back; to decision box 1028 where the candidate is given the option to continue reviewing jobs in the queue or terminating the search in the manner described above.

Going back to decision box 1014, if the employer has elected to receive a telephone communication from the candidate, the IVR system initiates an outbound telephone call to the employer, represented by the flow diagram 1018. In decision box 1020 the IVR system determines if the employer answered the telephone call. If the employer does not answer the telephone call from the IVR system, the Matching system delivers the interested candidate's resume to the employer by email or fax and the IVR system plays a message to the candidate that the call was not answered and the profile has been forwarded to the employer, represented by the flow diagram 1030. The logic flows to decision box 1028 where the candidate must decide if he would like to continue the process as described above.

Moving back to decision box 1020, if the employer answers the telephone call, the IVR system plays an audio file informing the employer of the reason for the call, represented by the flow diagram 1022. The employer and the candidate are instantly connected telephonically by the IVR system where they may communicate interactively, including discussion about the job opportunity and the candidate's qualifications, represented by the flow diagram 1024, Once the employer and candidate have terminated their call, the IVR system returns the results of the communication in a VoiceXML file, which is processed by the Matching system and the results recorded in the database, represented by the flow diagram 1026. The logic proceeds to decision box 1028 where the candidate is presented with the decision to continue searching jobs or terminate the search process. The candidate may continue reviewing each job opportunity in the queue until the queue is empty, or until the candidate terminates the search.

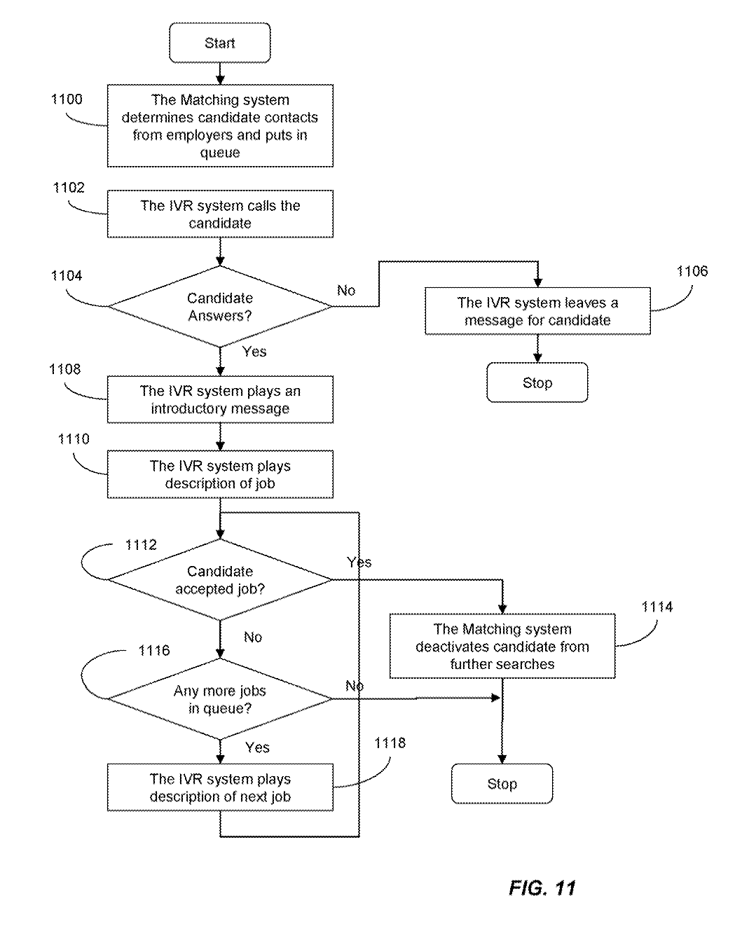

FIG. 11 is the flow diagram that illustrates the steps of the Matching system and IVR system confirming whether a candidate has obtained employment, in one embodiment of the invention. The process begins in logic diagram 1100 where the Matching system determines each job opportunity for which a candidate has been contacted, or for which the candidate contacted the employer. For each candidate, the Matching system creates a queue of each job description and instructs the IVR system to convert the job description into an audio file. The IVR system initiates an outbound call to the candidate, represented by flow diagram 1102. The IVR system next, at decision box 1104, determines if the candidate answers the phone. If the candidate does not answer, the IVR system returns the results of the communication in a VoiceXML file, which is processed by the Matching system and the results recorded in the database, represented by the flow diagram 1106.

Moving back to decision box 1104, if the candidate answers the telephone call, the IVR system plays an audio file in the language preference of the candidate, informing the candidate of the reason for the call, represented by the flow diagram 1108. The IVR system next plays an audio file of the description of the first job in the queue, represented by flow diagram 1110. Moving to (low diagram 1112, the IVR system prompts the candidate for an audio or telephonic response if the candidate is employed in the job described. If the candidate responds in the affirmative, the IVR system returns the results of the communication in a VoiceXML file, which is processed by the Matching system. The candidate is then removed from being included in active job searches by employers, and the results are recorded in the database, represented by the flow diagram 1114. If the candidate is not employed in the job described, the process moves to decision box 1116 where the IVR system determines if there are additional jobs in the queue for the candidate. If there are no more jobs in the queue, the process terminates. If there is an additional job in the queue, the IVR system plays the audio file with the description of the next job, represented by flow diagram 1118. The process flows to decision box 1112 where the IVR system prompts the candidate for a response to whether the candidate is employed in the job described. The process continues until the queue is exhausted or the candidate answers in the affirmative to decision box 1112.

In one embodiment of the invention, the Matching system includes an advertising system in which each communication to a potential candidate is accompanied by an advertisement of various products or services. In the example of a phone-based communication via an IVR system, an audio message containing the advertisement is played to the potential candidate in the language of his choice. The audio advertisement can be interrupted by the candidate by voice or telephone keypad if the candidate is interested in the product or service, at which point the candidate is either directly connected to the advertiser, or his name and contact information are forwarded to the advertiser. The system has the ability to determine how many times each audio advertisement is to be played as well as target specific candidates with specific advertisements based on factors such as the candidate's specified job criteria, skill-set, or geographic area.

Although the present invention has been described in considerable detail with reference to certain preferred configurations thereof, other versions are possible. The invention can be used in many situations and can be used with many different types of employers and candidates. The invention can also be used in any environment where two or more parties may achieve instant communication upon criteria matching the parties, it can function using different components and methods of communication. Therefore, the spirit and scope of the appended claims should not be limited to the preferred embodiments described in the specification.

What is claimed is:

1. A method of matching a first user with a second user based upon certain criteria and brokering instant communication between the first user and the second user comprising:
Parsing said first user qualification data;
Storing said first user qualification data;
Receiving search requests from said second user based upon certain criteria to be applied to said first user qualification data;
Comparing the certain criteria of said second user with said qualification data of said first user to determine if a match results;
Providing the results of said search and comparison, including revealing the identification information of said first user, to said second user; and
Brokering instantaneous communication between said second user and said first user.

2. The method according to claim 1, wherein the step of brokering instantaneous communications, further includes the step of sending said qualification data of said first user to said second user by electronic transmission.

3. The method according to claim 1, wherein the step of brokering instantaneous communications, further includes the step of brokering telephonic communication between said first user and said second user.

4. The method according to claim 1, wherein the step of brokering instantaneous communications further comprises the steps of:
telephonically calling said first user;
telephonically calling said second user; and
interactively connecting; said first user and said second user.

5. The method according to claim 1, wherein the step of brokering instantaneous communications, further includes communication in the language according to the language preference of said first user;

6. The method according to claim 1, wherein the step of brokering instantaneous communications further comprises the steps of:
telephonically calling said first user;
audibly providing a description of said search parameters to said first user in the language preference of the first user;
determining if said first user is expressing a positive response to said communication;
if response of said first user is positive, telephonically calling said second user; and
interactively connecting said first user and said second user.

7. A method of matching a candidate for employment with an employer based upon certain job related parameters and brokering instant communication between said candidate and said employer comprising:
Receiving search request from said employer based upon said certain job related parameters to be applied to said candidate qualification data;
Parsing said candidate's qualification data;
Comparing the said certain job related parameters of said employer with said qualification data of said candidate to determine if a match results;
Displaying the results of said search and comparison, including revealing the identification information of said candidate, to said employer interactively via a web interface; and
Brokering instantaneous communication between said employer and said candidate.

8. The method according to claim 7, wherein the step of brokering instantaneous communications, further includes the step of sending said candidate's profile to said employer by electronic transmission.

9. The method according to claim 7, wherein the step of brokering instantaneous communications, further includes the step of brokering an interactive communication between said candidate and said employer.

10. The method according to claim 7, wherein the step of brokering instantaneous communications, further comprises the steps of;
telephonically calling said candidate;
telephonically calling said employer; and
interactively connecting said candidate with said employer.

11. The method according to claim 1, wherein said communication is in the language according to the language preference of candidate.

12. The method, according to claim 7, wherein the step of brokering instantaneous communications further comprises the steps of:
telephonically calling the candidate;
audibly providing a description of said job related parameters to said candidate;
determining if said candidate is expressing a positive response to said communication;
if response of candidate is positive, telephonically calling said employer; and
interactively connecting said candidate and said employer.

13. The method, according to claim 7, wherein the step of brokering instantaneous communications further comprises the steps of:
telephonically calling the candidate;
audibly providing an advertisement communication to candidate;
determining if said candidate is expressing a positive response to said advertisement message;
if response of candidate is positive, telephonically calling said advertiser; and
interactively connecting said candidate and said advertiser.

14. A method of matching a candidate for employment with an employer based upon said candidate's qualification parameters and brokering instant communication between said candidate and said employer comprising the steps of:
Receiving search request from said candidate using an interactive interface in the language preference of said candidate, based upon said candidate's qualification parameters to be applied to job related data;
Parsing the job related data;
Comparing said candidate's qualification parameters with the job related data of said employer to determine if a match results;
Displaying the results of the search and comparison, including the identification information of the employer, to said candidate; and
Brokering instantaneous communication between said employer and said candidate.

15. The method according to claim 14, wherein the step of brokering instantaneous communication further includes the step of communicating said candidate's profile to the employer by electronic transmission.

16. The method according to claim 14, wherein the step of brokering instantaneous communication further includes the step of brokering interactive communication in the language preference of said candidate, between said candidate and said employer.

17. The method according to claim 14, wherein the step of brokering instantaneous communication further comprises the steps of:
telephonically calling said candidate;
telephonically calling said employer; and
interactively connecting said candidate and said employer.

18. The method according to claim 14, wherein the step of receiving the search request of said candidate is by telephone.

19. A method of matching an employer with a candidate for employment based upon certain criteria and brokering instant communication between said candidate and said employer comprising the steps of.
Receiving search request from said employer based upon said job related parameters to be applied to said candidate qualification data;
Parsing said candidate's qualification data;
Comparing said job related parameters of said employer with said qualification data of said candidate to determine if a match results;
Displaying the results of the search and comparison, including the identification information of said candidate, to said employer;
Creating a queue of all said candidates whose qualification data matches said job related parameters;
Creating an audio description of said job related parameters;
Translating said audio description into the language contained in the language preference of each said candidate;
Telephonically calling said candidate;
Playing said audio description to candidate and request the candidate respond with an expression of interest in said employment;
Receive said candidate's expression of interest in applying for said employment; and
Brokering instantaneous communication between the employer and the candidate.

20. The method, according to claim 19, wherein the step of brokering instantaneous communication, further includes the step of communicating said candidate's profile by electronic transmission.

21 The method according to claim 19, wherein the step of brokering instantaneous communication, further includes the step of interactively connecting said candidate with said employer.

22. The method according to claim 19, wherein the step of brokering instantaneous communication, further comprises the steps of:
telephonically calling said employer; and
telephonically calling said candidate.

23. The method according to claim 22, where said candidate does not answer said telephonic call to said candidate further comprises the steps of:
determining if said candidate has not answered said telephonic call a predetermined number of times; and
changing the availability indicator in said candidate's profile to indicate said candidate is not available for employment.

24. A system for matching a first user with a second user and brokering instant communication between the first user and the second user, the system comprising:
an electronic searchable database to store data that is comprised of a plurality of user data entries, and each said plurality of user data entries comprises either qualification data or search parameters;
a search system to search the qualification data of user data entries containing search parameters,
a search result reporting system to electronically report the user data entries containing the search parameters; and
a communication system to facilitate the instant communication between a recipient of the electronic report and a user containing the search parameters; and
said reporting system is operatively connected to the communication system which converts said user data entries into audio files in the language preference of the user for use by said communication system.

25. The system of claim 24, wherein said communication system facilitates instant communication of a user's data entries to said recipient by electronic transmission.

26. The system of claim 24, wherein said communication system is operatively connected to said search system which allows a user to search said database of users by entering search parameters telephonically.

27. The system of claim 24, wherein said communication system is operatively connected to said search system which allows a user to modify said database of user data by entering said data telephonically.

28. The system of claim 24, wherein said communication system interactively connects first user with second user telephonically.

29. The system of claim 24, wherein said searchable database contains user data, where said user data further comprises an availability indicator.
